(19) United States
(12) Patent Application Publication
(10) Pub. No.: US 2010/0293018 A1
(43) Pub. Date: Nov. 18, 2010

(54) Test Model Abstraction For Testability in Product Line Engineering

(75) Inventors: Andre Heuer, Essen (DE); Christof Budnik, Lawrenceville, NJ (US); Sascha J. Konrad, Plainsboro, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporation, Iselin, NJ (US)

(21) Appl. No.: 12/779,110

(22) Filed: May 13, 2010

Related U.S. Application Data
(60) Provisional application No. 61/178,100, filed on May 14, 2009.

(51) Int. Cl. G06Q 10/00; G06Q 90/00

(52) U.S. Cl. 705/7; 705/500

(57) ABSTRACT

Product line engineering testing is provided by segmenting a workflow into variable and common activity areas. A workflow decision node can be generated to isolate the segmented variable area, and a stub activity is generated and substituted into the workflow in place of the segmented variable activities. The stub activity can be configured to generate valid output for the substituted variable activities, and can be configured for black-box, gray-box, and white-box behavior.

This application claims the benefit of U.S. Provisional Application No. 61/178,100, filed May 14, 2009, which is incorporated herein by reference.

### FIELD OF THE INVENTION

The present invention is generally directed to test model abstraction, and more particularly to domain engineering testing in product line engineering.

### BACKGROUND

Many products, such as software, are released as part of a product line or in multiple variants of the product. Typically, the various products of a product line or the product variants include certain portions of design and engineering that are reused in each product and product variant. However, good industrial practice requires that each product and variant thereof be tested and verified as meeting the design requirements. Verification processes typically result in largely redundant testing because the re-used or common portions of the product line are retested for each product or variant.

Accordingly, improvements in product line engineering and testing product line engineering would be desirable.

### SUMMARY OF THE INVENTION

In accordance with one aspect of the present invention, a system and method for product line engineering testing is provided. More specifically, a workflow diagram associated with the product line engineering is segmented to identify a variable activity areas. A stub activity is generated for the variable activity area and substituted into the workflow in place of the variable activity area.

In accordance with a further aspect of the present invention, the stub activity can be configured to generate valid output for the variable activities of the variable activity area. Furthermore, the stub activity can replace multiple variable activities and can be further configured to generate valid output for each of the variable activities replaced. Stub activities can be used for black-box, gray-box, and white-box testing.

In yet a further aspect of the present invention, a workflow decision node can be generated to isolate the segmented variable area. The generated workflow decision node can then be inserted into the workflow diagram prior to the segmented variable activities. Segmented variable activities can include decision nodes, such that the stub activity is substituted for the decision node.

These and other advantages of the invention will be apparent to those of ordinary skill in the art by reference to the following detailed description and the accompanying drawings.

### BRIEF DESCRIPTION OF THE DRAWINGS

FIG. 1 is a flowchart of a process in accordance with an embodiment of the present invention;

FIG. 2 is a workflow diagram in accordance with an embodiment of the present invention;

FIG. 3 is a further workflow diagram in accordance with an embodiment of the present invention;

FIG. 4 is a further workflow diagram in accordance with an embodiment of the present invention; and

FIG. 5 is a high-level block level diagram of a computing device in accordance with an embodiment of the present invention.

### DETAILED DESCRIPTION

Software Product line engineering (SPLE) can be used to develop similar products in a cost effective manner with increased quality and reduced time to market. One focus of SPLE is the development of reusable parts or software artifacts (i.e., domain artifacts), which can be used within multiple versions of a product line. Thus, the development process for SPLE is divided into two processes: Domain Engineering for reusable elements and Application Engineering for application specific elements.

As the number of domain artifacts increases, the number of test artifacts increases combinatorially. At an application level, testing is costly because of redundancies in testing all common features for each variant of the software product. Furthermore, at the application level, testing errors that are discovered during testing are more costly to correct. Therefore, testing is preferably performed as much as possible during domain engineering in order to reduce effort and save cost. However, since changes in domain engineering, application engineering, and variability result in changes to the various test cases, it is preferable that only one test model be used for test case generation. Thus, in accordance with an embodiment of the present invention, the test artifacts can be organized to allow for efficient testing of applications derived from the domain artifacts. Specifically, various levels of abstraction can be used to allow for testing in domain engineering as well as application engineering.

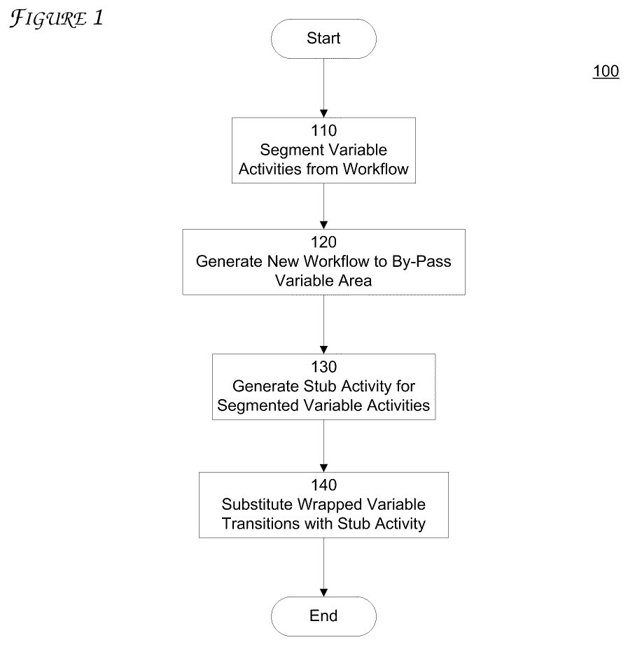

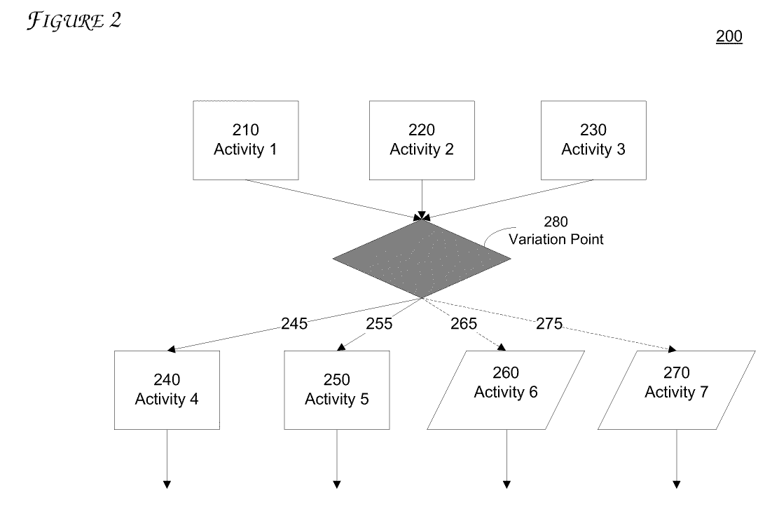

FIG. 1 is a flowchart of a process 100 in accordance with an embodiment of the present invention. Process 100 operates on a variable workflow model that identifies the commonalities and variabilities (e.g., inclusion or exclusion of features and/or software artifacts) of a product line. Use cases are used to develop a requirements model, which is transformed into the variable workflow model. Such a model captures the constraints between different variation points, for example by including one feature, but excluding another, from a product. The variability information is captured using variation points. Identification of variable transitions can be accomplished, for example, by the system and methods disclosed in U.S. Provisional Application No. 61/175,529, which is incorporated herein by reference. Process 100 is described below with respect to the variable workflow models illustrated in FIGS. 2, 3, and 4.

FIG. 2 illustrates an exemplary variable workflow model, in which variation points are represented as shaded decision points. More specifically, FIG. 2 illustrates a workflow 200, having Activity-1 210, Activity-2 220, and Activity-3 230. As illustrated, these activities lead to Variation Point 280 from which the workflow may test Activity-4 240, Activity-5 250, Activity-6 260, or Activity-7 270. Activity-6 260 and Activity-7 270 are variable activities (illustrated as rhomboid) and are not included in all software variants. Accordingly, variation point 280 has a mixture of common outgoing edges (illustrated as sold lines) and variable outgoing edges (illustrated as broken lines). Specifically, edges 245 and 255 leading to Activity-4 240 and Activity-5 250 are common to all software variants. However, edges 265 and 275 are variable, similar to Activity-6 260 and Activity-7 270, and are not included in all software variants.

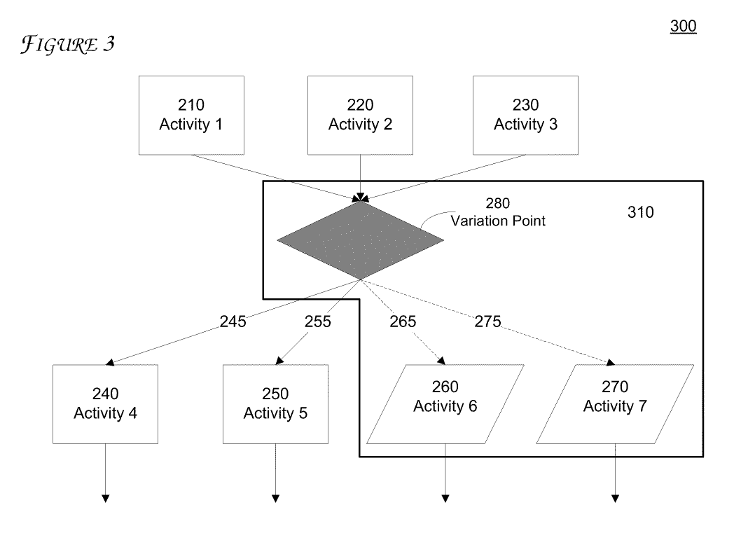

Thus, once the variable transitions and activities have been identified, at step 110 the variable activities can be segmented from the workflow. The segmentation of the identified variable activities is shown in FIG. 3, which illustrates a variable workflow 300, similar to workflow 200. Specifically, as illustrated in workflow 300, variable activities Activity-6 260 and Activity-7 270 along with transition edges 265 and 275 and Variation point 280 are segmented (e.g., wrapped) by boundary 310.

Because variation point 280 has a mixture of common and variable outgoing edges, variable edges 265 and 275 leading respectively to Activity-6 260 and Activity-7 270 cannot be isolated from workflow 300. Thus, variation point 280 must be wrapped and segmented along with edges 265 and 275, Activity-6 260, and Activity-7 270. Accordingly, at step 120 of process 100, a new workflow is generated to by-pass the variable activities of the workflow.

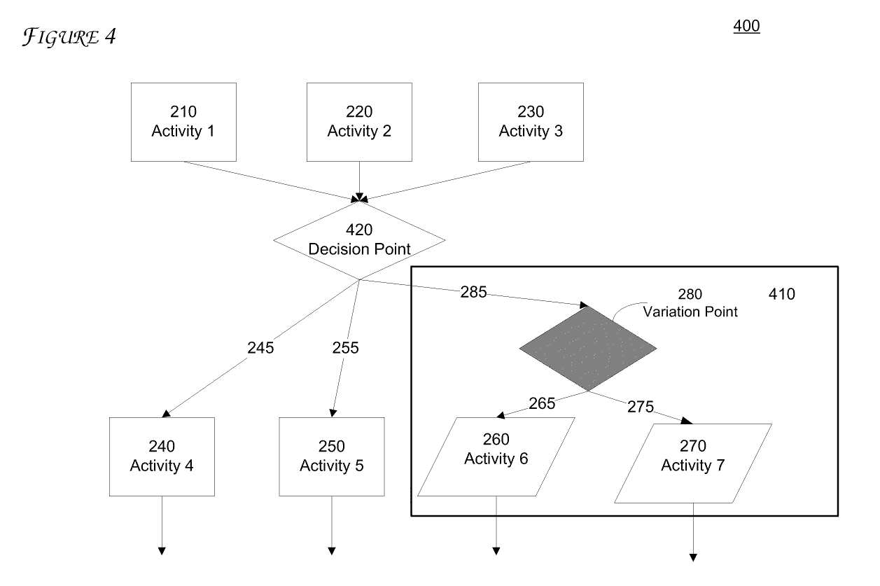

The variable activities may include a variation point (e.g., variation point 280), in which case, generation of the new work flow can include generation of a decision point (i.e., FIG. 4, decision point 420). Decision point 420 is inserted into the workflow prior to the variable activities. The generation of decision point 420 and insertion into the workflow is illustrated in workflow 400 of FIG. 4. Workflow 400 is a transformation of workflow 300 after step 120 of process 100. It should be noted that insertion of decision point 420 results in the variable area being an isolated variable area 410. That is, all edges leading from decision point 280 (e.g., edges 245, 255, and 285) are common edges and therefore included in domain testing.

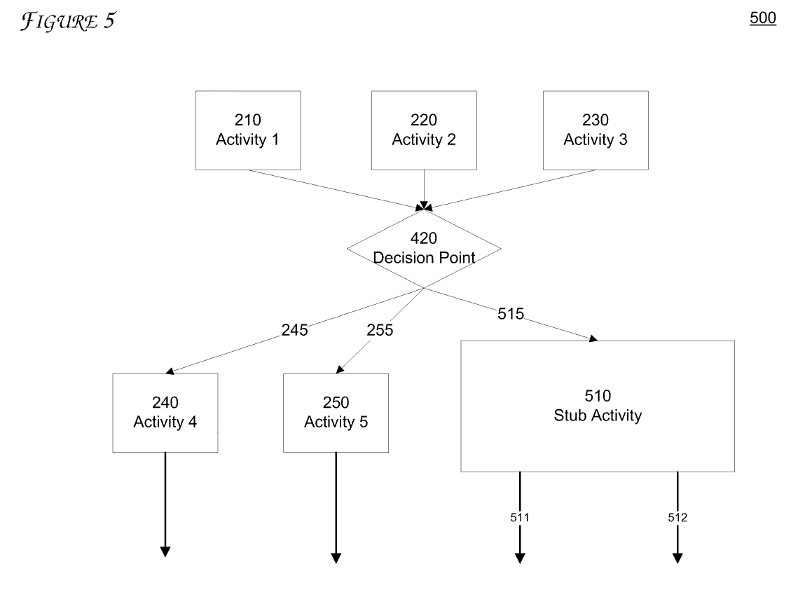

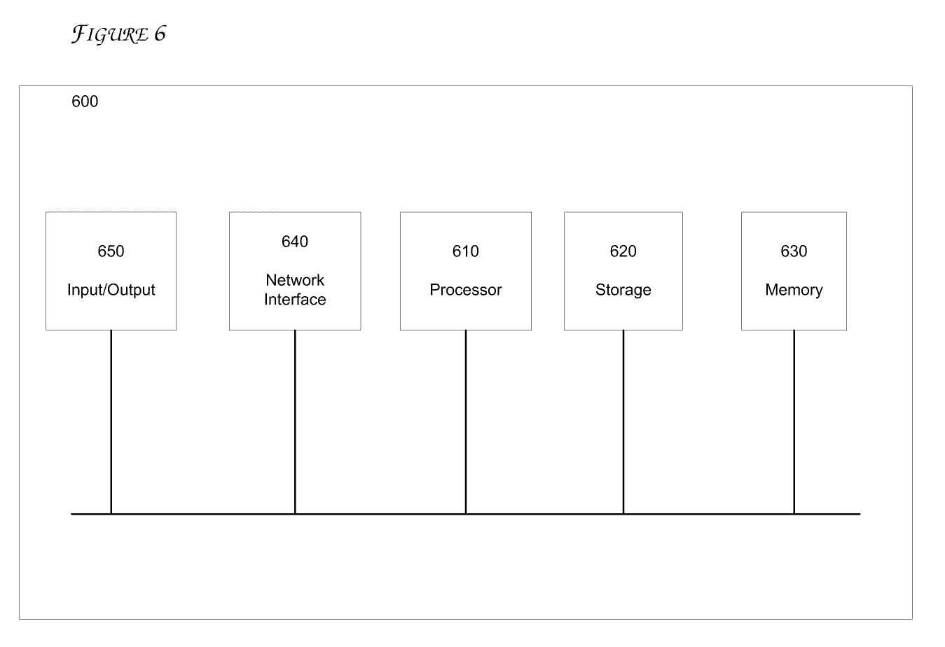

As illustrated in workflow 500 of FIG. 5, the isolated variable area 410 illustrated in workflow 400 can be replaced by a stub activity 510 that simulates certain behaviors for domain testing purposes. Thus, at step 130 of process 100, a stub activity 510 is generated for the segmented variable activities. The stub activity 510 can be configured to generate valid output for the variable activities (e.g., Activity-6 260 and Activity-7 270) of the isolated variable area 410.

Specifically, because stub-activity 510 is being substituted for two activities (e.g., Activity-6 260 and Activity-7 270) the stub activity 510 can generate output in two ranges: a first range corresponding to the range of valid output for Activity-6 260, and a second range corresponding to the range of valid output for Activity-7 270. Accordingly, as illustrated, a single incoming edge 515 leads to stub activity 510. However, two edges 511 and 512 are illustrated as outgoing from stub activity 510. Each outgoing edge 511 and 512 represents a range of valid output. For example, edge 511 can represent the valid output of Activity-6 260, which was replaced by stub activity 510, and edge 512 can represent the valid output of Activity-7 270, which was also replaced by stub activity 510. If additional activities were replaced by stub activity 510, additional outgoing edges representing the appropriate range of valid output can be included in workflow 500 as outgoing from stub-activity 510.

Stub activity 510 can be configured in a variety of ways to increase testability and control domain level testing. For example, stub-activity 510 can be configured for black-box, white-box, or gray box testing. Further configurations generate random output within the valid range of output. Alternatively, the stub activity can generate output based on a script of output, which can itself be generated manually or by tracelogs captured from previous software runs (e.g., using previous iterations of software artifacts).

By abstracting the variability from the workflow test model, significant savings, in both time and cost, can be realized. Another benefit is that the commonalities between variants become testable even if they are within workflow paths that contain variable activities. Typically, commonalities are only tested in totally separated paths that contain no variable activities. Thus, paths through the workflow that are common to all software variants do not need to be retested with development of each application variant. Rather, the application testing can focus only on those use cases through the workflow that require variable activities.

The above-described methods for domain engineering testing in product line engineering can be implemented on a computer using well-known computer processors, memory units, storage devices, computer software, and other components. A high-level block diagram of such a computing device is illustrated in FIG. 6. Computer 600 contains a processor 610 which controls the overall operation of the computer 600 by executing computer program instructions which define such operations. The computer program instructions may be stored in a storage device 620, or other computer readable medium (e.g., magnetic disk, CD ROM, etc.), and loaded into memory 630 when execution of the computer program instructions is desired. Thus, the method steps of FIG. 1 can be defined by the computer program instructions stored in the memory 630 and/or storage 620 and controlled by the processor 610 executing the computer program instructions. For example, the computer program instructions can be implemented as computer executable code programmed by one skilled in the art to perform an algorithm defined by the method steps of FIG. 1. Accordingly, by executing the computer program instructions, the processor 510 executes an algorithm defined by the method steps of FIG. 1. The computer 600 also includes one or more network interfaces 640 for communicating with other devices via a network. The computer 600 also includes input/output devices 650 that enable user interaction with the computer 600 (e.g., display, keyboard, mouse, speakers, buttons, etc.) One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various functional modules that are shown are for illustrative purposes only, and may be combined, rearranged and/or otherwise modified.

We claim:

1. A method for product line testing comprising:
segmenting a variable activity of a workflow;
generating a stub activity for the variable activity; and
substituting the stub activity for the variable activity.

2. The method of claim 1, wherein generating the stub activity comprises configuring the stub activity to generate valid output for the substituted variable activity

3. The method of claim 2, wherein
segmenting the at least one variable activity comprises segmenting a plurality of variable activities,
generating the stub activity comprises configuring the stub activity to generate valid output for each of the plurality of variable activities, and
substituting the stub activity for the variable activity comprises substituting the stub activity for the plurality of variable activities.

4. The method of claim 3, wherein the plurality of variable activities includes a variable decision node.

5. The method of claim 1 further comprising:
generating a workflow decision node; and
inserting the workflow decision node into the workflow prior to the segmented variable activity.

6. The method of claim 1, wherein the stub activity comprises at least one of a black-box, a gray-box, and a white-box.

7. A system for product line testing comprising:
means for segmenting a variable activity of a workflow;
means for generating a stub activity for the variable activity; and
means for substituting the stub activity for the variable activity.

8. The system of claim 7, wherein
the means for segmenting the at least one variable activity comprises segmenting a plurality of variable activities,
the means for generating the stub-activity comprises means for configuring the stub activity to generate valid output for the substituted variable activity, and
the means for substituting the stub activity for the variable activity comprises means for substituting the stub activity for the plurality of variable activities.

9. The system of claim 8, wherein the plurality of variable activities includes a variable decision node.

10. The system of claim 7 further comprising:
means for generating a workflow decision node; and
means for inserting the workflow decision node into the workflow prior to the segmented variable activity.

11. The system of claim 7, wherein the stub activity comprises at least one of a black-box, a gray-box, and a white-box.

12. An article of manufacture including a computer-readable medium having instructions stored there that, in response to execution by a computing device, cause the computing device to perform operations comprising:
segmenting a variable activity of a workflow;
generating a stub activity for the variable activity; and
substituting the stub activity for the variable activity.

13. The article of manufacture of claim 13, wherein the stub activity is configured to generate valid output for the substituted variable activity

14. The article of manufacture of claim 14, wherein
segmenting the at least one variable activity comprises segmenting a plurality of variable activities,
generating the stub activity comprises configuring the stub activity to generate valid output for each of the plurality of variable activities, and
substituting the stub activity for the variable activity comprises substituting the stub activity for the plurality of variable activities.

15. The article of manufacture of claim 14, wherein the plurality of variable activities includes a variable decision node.

16. The article of manufacture of claim 13, wherein the operations further comprise:
generating a workflow decision node; and
inserting the workflow decision node into the workflow prior to the segmented at least one variable activity.

17. The article of manufacture of claim 13, wherein the stub activity comprises at least one of black-box behavior, gray-box behavior, and white-box behavior.
